(19) United States
(12) Patent Application Publication
(10) Pub. No.: US 2023/0311434 A1
(43) Pub. Date: Oct. 5, 2023

(54) A MOULDING ASSEMBLY FOR MANUFACTURING A SHELL PART OF A WIND TURBINE BLADE

(71) Applicant: LM Wind Power A/S, Kolding (DK)

(72) Inventors: Kristian Lehmann Madsen, Kolding (DK); Frederik Brandt, Kolding (DK)

(21) Appl. No.: 18/043,779

(22) PCT Filed: Sep. 2, 2021
(86) PCT No.: PCT/EP2021/074232

§ 371 Date: Mar. 2, 2023

(30) Foreign Application Priority Data
Sep. 3, 2020 (GB) 2013862.4

(51) Int. Cl. B29C 70/54

(52) U.S. Cl. CPC B29C 70/541; B29L 2031/085

(57) ABSTRACT

The present invention relates to a moulding assembly (100) for manufacturing a shell part of a wind turbine blade, and to methods of manufacturing a shell part of a wind turbine blade using the moulding assembly. The moulding assembly (100) comprises a blade mould (96) with a moulding cavity (97), a gripping device (76) for releasably engaging a preform (98) for the shell part, and a lifting device (102). The lifting device comprises a first hoisting device (104a) and a second hoisting device (104b), each of the first and second hoisting devices comprising a respective load engaging member (110a, 110b) for connecting the first and the second hoisting devices (104a, 104b) to the gripping device.

### FIELD OF THE INVENTION

The present invention relates to a moulding assembly for manufacturing a shell part of a wind turbine blade, and to a method of manufacturing a shell part of a wind turbine blade using the moulding assembly.

### BACKGROUND OF THE INVENTION

Wind is an increasingly popular clean source of renewable energy with no air or water pollution. When the wind blows, wind turbine rotor blades spin clockwise, capturing energy through a main shaft connected to a gearbox and a generator for producing electricity. Rotor blades of modern wind turbines are carefully designed to maximise efficiency. Modern rotor blades may exceed 80 metres in length and 4 metres in width.

Wind turbine rotor blades are typically made from a fibre-reinforced polymer material, comprising a pressure side shell half and a suction side shell half, also called blade halves. The cross-sectional profile of a typical blade includes an airfoil for creating an air flow leading to a pressure difference between both sides. The resulting lift force generates torque for producing electricity.

The shell halves of rotor blades are often manufactured using blade moulds. First, a blade gel coat or primer is applied to the mould. Subsequently, fibre reinforcement and/or fabrics are placed into the mould followed by resin infusion. A vacuum is typically used to draw epoxy resin material into a mould. Alternatively, prepreg technology can be used in which a fibre or fabric pre-impregnated with resin forms a homogenous material which can be introduced into the mould. Several other moulding techniques are known for manufacturing wind turbine blades, including compression moulding and resin transfer moulding. The shell halves are assembled by being glued or bolted together substantially along a chord plane of the blade.

In such blade manufacturing processes, the use of preforms becomes increasingly important. A preform is a shaped arrangement of fibres, such as multiple layers thereof, which has been bound and/or consolidated for later use as part of the fibre lay-up in the blade mould. The rationale for using preforms for blade manufacturing is to reduce cycle time in the blade mould. In addition, using preforms may reduce the number of required repairs due to the pre-consolidated structure of the preforms. As blade lengths increase, using preforms for blade lay-up adds efficiency and precision.

Typically, multiple preforms will be used in manufacturing a wind turbine blade, whereas sometimes only one preform is used for each shell. This usually requires large space for manufacturing and for storing the preforms. In addition, the manufacturing of preforms of different shapes and sizes can be time-consuming and expensive. Providing moulds for manufacturing preforms can be tedious and costly, which applies even more if preforms of various shapes and curvatures are required. Equipment for handling such various preforms will often take up a large space during storage.

A shell half of a modern wind turbine blade may comprise different preforms of 20 or more slightly different geometries, which provides certain challenges in particular with regard to transferring the different preforms from their respective preform moulds to the blade mould. One solution may be to design a plurality of different transfer jigs adapted to the various preform geometries. However, this may be a tedious and costly process. In addition, new modifications will have to be made for each new preform geometries.

Another challenge arises from the fact that a subset of the preforms that are to be arranged in the blade mould need to be arranged in a tilted or even substantially vertical position. This applies in particular to the root region of the blade mould. This involves the risk of undesired preform sliding due to the force of gravity and resulting wrinkle formation or other material defects.

It is therefore a first object of the present invention to provide an efficient and safe method of arranging preforms for a wind turbine blade shell part in the blade mould.

It is a further object of the present invention to provide a flexible and efficient tool or assembly for such methods.

It is another object of the present invention to provide an improved method of manufacturing a wind turbine blade using multiple preforms which are to be arranged at different locations within the blade mould.

### SUMMARY OF THE INVENTION

The present invention addresses one or more of the above-discussed objects by providing a moulding assembly for manufacturing a shell part of a wind turbine blade, the moulding assembly comprising a blade mould for moulding the shell part, the blade mould comprising a moulding cavity, a gripping device for releasably engaging a preform for the shell part, a lifting device comprising a first hoisting device and a second hoisting device, each of the first and second hoisting devices comprising a respective load engaging member for connecting the first and the second hoisting devices to the gripping device, wherein the gripping device is connected to the lifting device at the respective load engaging members of the first and second hoisting devices, such that the load engaging members are spaced apart from another.

The moulding assembly of the present invention is found to allow for an efficient and accurate arrangement of preforms within the moulding cavity of the blade mould. This applies in particular to the root region of the blade mould, in which preforms may have to be precisely arranged in inclined or even substantially vertical positions. By using a lifting device comprising two hoisting devices with respective load engaging members, the gripping device can be tilted to the correct position for arranging the preform in the blade mould.

The blade mould is typically a blade mould for a shell half of a wind turbine blade, such as a pressure side shell half or a suction side shell half. Thus, the shell part is preferably a shell half of a blade, such as a downwind shell half or an upwind shell half. In some embodiments, the method of manufacturing a shell part according to the present invention may involve arranging preforms in a prefab mould with subsequent infusing of resin and curing for manufacturing sub parts for later blade assembly. In some embodiments, the shell part is a root laminate, a main laminate or a part thereof. In another embodiment, the shell part is a blade half. In other embodiments, the shell part is a full blade.

Preferably, the preform to be used in the present methods is a consolidated arrangement of material comprising fibres, such as glass fibres, and a binding agent. The preform will typically be used for manufacturing a blade half of a wind turbine blade. The manufactured preforms can be used in a blade moulding process as part of the fibre lay-up in the blade mould. The preforms used according to the present invention can be placed within the root region of a blade mould, thus constituting part of the root laminate. The root region may correspond to a region of the blade having a substantially circular or elliptical cross-section. However, the preforms could also be used for other parts and regions of a wind turbine blade, such as trailing edge or leading-edge reinforcements or adhesive flanges. Alternatively, the preforms could be used for a full blade layup.

The gripping device for releasably engaging a preform for the shell part of the present invention preferably comprises one or more needle grippers for engaging and releasing the preform. The gripping device may comprise a support frame to which the respective load engaging members, such as hooks or attachment eyes, of the first and second hoisting devices of the lifting device may be attached.

The lifting device preferably comprises a holder, such as an upper hook, which can be suspended from scaffolding, a gantry or a crane. In a preferred embodiment, the lifting device comprises a dual chain hoist, wherein each chain hoist constitutes a respective hoisting device. Thus, each of the first and second hoisting devices is preferably a chain hoist. Each of the first and second hoisting devices may comprise a load chain and a lifting chain wheel, wherein the respective load engaging members are preferably arranged at the respective free ends of the load chain. Each of the load engaging members may take the form of a hook or an attachment eye, or similar fastening means, for engaging the gripping device. In a preferred embodiment, the gripping device comprises a base frame, wherein the load engaging members engage the base frame of the gripping device.

In other embodiments, each of the first and second hoisting device is a power-operated hoist driven by a common or separate driving motor(s), such as an electric motor. In some embodiments, each of the hoisting devices comprises a differential pulley.

The gripping device is connected to the lifting device at the respective load engaging members of the first and second hoisting devices, such that the load engaging members are spaced apart from another when connected to the gripping device. This is typically implemented in that the respective load engaging members, such as hooks or attachment eyes, are connected at different locations of the gripping device, such as at different locations along a base frame of the gripping device. It is preferred that each of the respective load engaging members, for example each of the lower hooks, are connected at opposing sides of the gripping device, e.g. at a left and right side of a support frame of the gripping device. In other embodiments, each of the respective load engaging members, for example each of the lower hooks, are connected at opposing corners or opposing edges of the gripping device, for example at opposing corners or or opposing edges of a support frame or base frame of the gripping device. Advantageously, the load engaging members are spaced apart from another when connected to the gripping device such that tilting of the gripping device is conveniently enabled by using the lifting device. Thus, the gripping device can be advantageously tilted using the lifting device with the respective hoisting devices, leading to improved accuracy when arranging the preforms in the blade mould.

In a preferred embodiment, the respective load engaging members of the first and second hoisting devices are spaced apart from another when connected to the gripping device by a linear distance of at least 0.5 m, more preferably at least 1 m, most preferably at least 2 m.

In some embodiments, the moulding assembly of the present invention allows for tilting the gripping device such that a plane of the engaged preform, or a tangent to the curved lower surface of the preform, forms an angle with the ground surface of at least 45 degrees, preferably at least 60 degrees, such as at least 75 degrees.

According to a particularly preferred embodiment, the moulding assembly further comprises a rigid arm with a proximal end and an opposing distal end, wherein the proximal end of the rigid arm is anchored to the blade mould, such as to a mould edge of the blade mould, and wherein the rigid arm is releasably fastened to the gripping device at the distal end of the rigid arm or at a location in between the proximal end and the distal end of the rigid arm. Thus, the rigid arm can be advantageously used to further guide the gripping device towards the moulding surface, or to prevent movement of the gripping device away from the moulding surface, when lowering the gripping device from the lifting device. The proximal end of the rigid arm may be fixed to an edge of the blade mould or to an outer surface of the blade mould. In some embodiments, the proximal end of the rigid arm comprises an attachment eye which can be fixed to the blade mould by using one or more screws, bolts or pins.

In a preferred embodiment, the rigid arm is releasably fastened to the gripping device via an attachment frame which is mounted onto the gripping device, preferably onto a base frame of the gripping device. The attachment frame may comprise a fixture, such as a disc-shaped fixture, which is pivot-mounted on the attachment frame, wherein the fixture is arranged for receiving the rigid bar, such as the distal end of the rigid bar. This advantageously allows for slight changes of the angle between the rigid arm and the gripping device, when lowering the latter into the blade mould cavity.

It is particularly preferred that the rigid arm is a telescopic arm with adjustable length. In a preferred embodiment, the telescopic arm comprises a screw rod and a threaded sleeve receiving the screw rod for adjusting the length of the telescopic arm. The threaded sleeve may be rotatably connected to an element, such as one or more rods or bars, of the rigid arm, such that the threaded sleeve is free to rotate relative to said element. Thus, the length of the rigid arm can be adjusted according to the desired placement position of the preform.

In some embodiments, the rigid arm may further comprise a sliding element received in a (non-threaded) sleeve for adjusting the length of the rigid arm. This can be achieved by engaging/releasing a fixture between the sliding element and the non-threaded sleeve. To this end the sliding element may comprise one or more securing pins which can be received in one of a series of aligned holes in the sleeve. Thus, by moving the securing pin from one hole to another hole, the length of the rigid arm can be adjusted for meeting the requirements of the particular preform arrangement at hand.

It is preferred that the first hoisting device is independently operable from the second hoisting device. Thus, tilting of the gripping device can be achieved by lowering load engaging member of one hoisting device to a greater or lesser extent than the load engaging member of the other hoisting device.

In a preferred embodiment, the respective load engaging members of the first and second hoisting devices are connected at opposing ends of the gripping device, such as at opposing sides, opposing edges or opposing corners of the gripping device, such as at opposing sides, opposing edges or opposing corners of a base frame of the gripping device. This provides an advantageous degree of tilting capability of the gripping device during preform arrangement in the blade mould.

In a preferred embodiment, the first hoisting device and/or the second hoisting device comprises a chain hoist with a load chain, the respective load engaging member being located at the free end of the load chain. The respective load engaging member may take the form of a hook or an attachment eye, or other fastening suitable for engaging the gripping device.

In a preferred embodiment, the lifting device comprises a dual chain hoist arrangement comprising a first chain wheel which is part of the first hoisting device, and a second chain wheel which is part of the second hoisting device. In a preferred embodiment, each hoisting device comprises a cable or a chain, wherein the load engaging member is arranged at the distal end, i.e. at the free end, of the cable or chain. It is preferred that the lifting device is suspended from a gantry or crane arranged above the blade mould.

In a preferred embodiment, the blade mould comprises a first mould edge and an opposing second mould edge, wherein the moulding assembly further comprises a socket member attached to the first or to the second mould edge, wherein the gripping device comprises one or more pivot connectors adapted for being received in the socket member. In a preferred embodiment, a base frame of the gripping device, or a part attached to said base frame, comprises one or more pivot connectors, or parts thereof, adapted for being received in a socket member attached to the blade mould. The socket member may be attached to an edge or a rim of a wind turbine blade mould, i.e. a mould for moulding a wind turbine blade shell half The socket member may be affixed to a support or pole member for attachment to the blade mould. Thus, when the preform held by the gripping device is suspended above the blade mould, one or more of the pivot connectors, or parts thereof, may be received in one or more socket member attached to the blade mould, such that the perform can be pivoted by simply lowering the gripping device with a crane above the blade mould. In some embodiments, the pivot connector comprises a ball member such as a hitch ball for a ball-and-socket hitch. In some embodiments, the base frame comprises one or more horizontally extending sheath members, such as two horizontally extending sheath members arranged to receive respective support members, such as angled support members, each support member carrying a pivot connector, or a part thereof, in the form of a ball member at its distal end. In this way, both the longitudinal and transverse location can be secured in a poka-yoke fashion.

In a preferred embodiment, the gripping device comprises a base frame, a plurality of arms slidably mounted on the base frame, each arm having a proximal end and a distal end, a plurality of gripping members for gripping a top surface of the preform, each gripping member being attached to the distal end of at least one of the arms, a plurality of lock members, each lock member being engaged with at least one of the arms for allowing sliding motion of the arm relative to the base frame in a first direction while preventing sliding motion of the arm relative to the base frame in a second direction.

This arrangement of the gripping device is found to be flexible and efficient in catering to various preform geometries, while not relying on complex control systems or computer-generated adaptions. Thus, a single gripping device can be used for gripping and transferring preforms of different shape and curvature as the gripping arms are slidable relative to the base frame in a first direct direction, preferably an upward direction. Since sliding motion of the gripping arms relative to the base frame in a second, preferably a downward direction, is prevented, the positions of the individual gripping arms relative to the base frame can be conserved for the next transfer of a preform of the same shape.

Such gripping device is useful for lifting a preform for a wind turbine blade from its preform mould and for transferring said preform to the blade mould. The base frame preferably comprises a plurality of vertically extending beams and a plurality of horizontally extending beams, such as steel beams. The horizontally extending beams may include longitudinally oriented beams and transversely oriented beams which extend substantially perpendicular to the longitudinally oriented beams.

In a preferred embodiment, the gripping device comprises a plurality of gripping arms slidably, preferably vertically slidably, mounted on the base frame, either directly or via one more support members or fixtures, such as one or more horizontally extending support members. Preferably, each gripping arm is slidable in a vertical direction, such as in an upward direction. Each gripping arm has a proximal end, which during operation is at the top of the device, i.e. nearest to the ceiling, and a distal end, which during operation is at the bottom of the device, i.e. nearest to the floor or to the preform top surface.

A gripping member is preferably attached to the distal end of a gripping arm, wherein the gripping member is suitable for gripping, i.e. attaching itself to, a top surface of the preform. A lock member is engaged with the gripping arm for allowing sliding motion of the gripping arm relative to the base frame in a first direction, preferably in an upward direction, while preventing sliding motion of the gripping arm relative to the base frame in a second direction, preferably in a downward direction. Thus, in a preferred embodiment, the first direction is an upward direction and the second direction is a downward direction.

Preferably, the lock member comprises, or consists of, a ratchet or a brake member. The lock member is advantageously arranged to prevent linear movement of the gripping arm in one direction and to allow linear movement of the gripping arm in the opposite direction relative to the base frame.

In some embodiments, each gripping arm is individually slidable relative to the base frame. This ensures that even complex top surfaces or shapes of a preform can be accurately engaged by each of the gripping arms carrying the respective gripping members. Such individual arrangement of the vertical position of each gripping arm relative to the base frame provides an elegant shape memory solution, ensuring that preforms of the same shape can be transferred from their respective preform moulds without altering the respective gripping arm positions and without any need to control the same through complex control units or computational means.

In some embodiments, the gripping device comprises at least three gripping arms, such as at least five gripping arms, with respective gripping members being attached to the distal end of the respective gripping arms. In some embodiments, the gripping device comprises between 8 and 400, more preferably 10-300 gripping arms, most preferably 100-200 gripping arms, with respective gripping members being attached to the distal end of the respective gripping arms.

In a preferred embodiment, the gripping device may be provided as a modular system, wherein the base frame is created from a plurality of equal modules and wherein all gripping arms are alike.

According to another embodiment, each gripping arm is slidably mounted within a slot arranged on the base frame. The slot may be provided by a fixture or bracket attached to the base frame, for example, via a horizontally extending support member or bar. Preferably, the gripping arm may slide upward within the slot, while downward movement is prevented.

In a preferred embodiment, sliding motion of the gripping arms relative to the base frame is achieved exclusively by gravity. Once a gripping arm has engaged the preform top surface via its gripping member, the gripping arm will preferably slide upward relative to the base frame when lowering the latter. In other words, sliding motion of the gripping arms relative to the base frame is preferably achieved by lowering the base frame while one or more of the gripping arms are engaged with, or pushed back by, the preform top surface. Thus, no actuation means other than a crane or lifting device suspending the gripping device is needed to achieve relative movement of the gripping arms in relation to the base frame. Thus, preferably, the positions of the gripping arms relative to the base frame is set/defined by the top surface geometry of the preform.

It is preferred that the vertical positions of the gripping arms relative to the base frame are not controlled by a computer or a control unit. The gripping device of the present invention thus provides a simple, yet efficient solution for custom-tailoring the gripping device to virtually all possible preform geometries.

In an alternative embodiment, the gripping arms are actuated by one or more pistons, such as pneumatic pistons, wherein the lock members comprise at least one valve for preventing sliding motion of the gripping arm relative to the base frame in a second direction.

In some embodiments, a programmable logic controller may be used to control whether the pistons should be in an entirely retracted or in an entirely extending position. Also, pistons can be used to create a threshold on the needle gripper while injecting the needles.

It is preferred that the gripping member is a needle gripper, such as a pneumatic needle gripper. The needle gripper preferably comprises a plurality of gripping needles which can be retracted into and extended from a gripper base part or a gripper housing. The gripping member is advantageously suitable for gripping a preform comprising a fabric, one or more fibre materials, and/or other materials that can be penetrated by needles. Useful needle grippers are disclosed in US 2016/0257509 A1 and U.S. Pat. No. 8,104,807 B2.

In another embodiment, the gripping member comprises a vacuum cup. In some embodiments, some of the gripping members are needle grippers, and some of the gripping members are vacuum cups.

In some embodiments, the gripping member releasably attaches to the preform upon contact with the top surface of the preform. Preferably, one or more needles of the gripping member penetrate the preform or a layer thereof

Preferably, each gripping arm is slidably arranged in a bracket or fixture mounted on the base frame. In one embodiment, the bracket or fixture comprises the lock member.

In another aspect, the present invention relates to a method of manufacturing a shell part of a wind turbine blade using the moulding assembly according to the present invention, the method comprising engaging a preform for the shell part with the gripping device, arranging the engaged preform within the moulding cavity of the blade mould by moving the gripping device and the engaged preform by means of the lifting device comprising the first hoisting device and the second hoisting device, and disengaging the preform from the gripping device. It is particularly preferred that the step of arranging the engaged preform within the moulding cavity of the blade mould includes tilting or turning the gripping device by means of the lifting device comprising the first hoisting device and the second hoisting device.

In a preferred embodiment, the step of arranging the engaged preform within the moulding cavity comprises engaging the gripping device with the rigid arm while lowering the gripping device and the engaged preform towards the moulding cavity by means of the lifting device. Thus, the gripping device may be prevented from moving away from the moulding cavity, or may even be pulled slightly towards the moulding cavity when a telescopic rigid arm is used.

In a preferred embodiment, the preform is manufactured in a preform mould, prior to engaging the preform with the gripping device, wherein the method further comprises the step of transferring the engaged preform to the blade mould using the lifting device prior to arranging the engaged preform within the moulding cavity of the blade mould.

In a preferred embodiment, the method further comprises the steps of
infusing resin into the blade mould after disengaging the preform from the gripping device, and
curing or hardening the resin in order to form the blade part.

Typically, the resin infusion step comprises vacuum assisted resin transfer moulding. In a preferred embodiment, the resin dissolves the binding agent of the preform. Other embodiments involve chemical binding, for example for epoxy or thermoset resins. The resin for injecting the preform during the manufacturing of wind turbine blade parts, such as a root laminate, may be an epoxy, a polyester, a vinyl ester or another suitable thermoplastic or duroplastic material. In other embodiments, the resin may be a thermosetting resin, such as epoxy, vinyl ester or polyester, or a thermoplastic resin, such as nylon, PVC, ABS, polypropylene or polyethylene.

In a preferred embodiment, each of the preforms is configured to form a blade section starting from the root end of the wind turbine blade. Thus, preferably each of the preforms is configured to be arranged at the root end of the blade mould. Most preferably, the preform is configured to form a subsection of the root section extending from the root end of the blade together with other subsections of the root section equally extending from the root end of the blade. In some embodiments, the preform mould comprises a moulding surface configured for the manufacturing of respective subsections of a wind turbine blade, each subsection extending from the root end of the wind turbine blade. In some embodiments, the preform mould has a concave, or inwardly curved, moulding surface.

The method of manufacturing a shell part of the present invention will usually comprise laying up additional material, such as fibre material, in the blade mould together with the preform(s). The preform will typically include fibre material and a binding agent to form the preform. Preferably, the fibre material and the binding agent are heated using one or more heating devices, such as an oven. Preferably, a binding agent is added to the fibres prior to the heating step. Such binding agent is preferably present in an amount of 0.1-15 wt % relative to the weight of the fibre material. The binding agent may also be present in an amount of 10-20 gram per square meter of glass surface. The fibre material may include fibre rovings, such as glass fibre rovings. The binding agent of the preform can be added simultaneously with the fibres or subsequently to fibre lay-up. The binding agent is preferably present in an amount of 0.1-15 wt % relative to the weight of the fibre material. The binding agent may also be present in an amount of 5-40, preferably 10-20, gram per square meter of glass surface. In preferred embodiments, the binding agent is present in an amount of 0.5-5 wt %, preferably 0.5-2.5 wt %, relative to the weight of the fibre material. Advantageously, the binding agent is a thermoplastic binding agent. The binding agent may comprise a polyester, preferably a bisphenolic polyester.

In a preferred embodiment, the heating of the fibre material and the binding agent to form the preform takes place at a temperature of between 40 and 160° C., preferably between 90 and 160° C. An example of a suitable binding agent for the preform is a polyester marketed under the name NEOXIL 940. Examples include NEOXIL 940 PMX, NEOXIL 940 KS 1 and NEOXIL 940 HF 2B, all manufactured by DSM Composite Resins AG. Another example is a polyester resin marketed under the name C.O.I.M. FILCO® 661 FPG 005, which is a bisphenolic unsaturated polyester resin in powder form. Preferably, the binding agent is a polyester, preferably a bisphenolic polyester. In other embodiments, the binding agent is a hotmelt adhesive or based on a prepreg resin.

According to another embodiment, the binding agent is a thermoplastic binding agent. Typically, the fibre rovings are at least partially joined together by means of the binding agent by thermal bonding. In a preferred embodiment, the binding agent is a binding powder, such as a thermoplastic binding powder. In one embodiment, the preforms of the present invention essentially consist of the fibre material and the binding agent. This means that the preforms contain no more than 10 wt %, preferably not more than 5 wt % or not more than 1 wt %, of material other than fibre material and binding agent relative to the total weight of the preform. According to another embodiment, the preform consists of the fibre material and the binding agent.

In another embodiment, the fibre material used for the preforms of the present invention essentially consists of glass fibres. This means that the fibre material contains not more than 10 wt %, preferably not more than 5 wt % or not more than 1 wt %, of material other than glass fibres relative to the total weight of the fibre material. According to another embodiment, the fibre material consists of glass fibres.

In one embodiment, the binding agent is present in an amount of 1-6 wt % relative to the weight of the fibre material. According to another embodiment, the melting point of the binding agent is between 40° and 220° C., preferably between 40 and 160° C. According to another embodiment, the binding agent comprises a polyester, preferably a bisphenolic polyester. In one embodiment of the present invention, each preform essentially consists of the fibre material and the binding agent. According to another embodiment, the fibre material comprises fibre rovings, preferably glass fibre rovings. In other embodiments, the fibre material may comprise carbon fibres or a hybrid material. According to another embodiment, the fibre material comprises a fibre fabric, such as a fibre mat. In another embodiment, a preform may further comprise at least one fibre fabric such as a fibre mat. Fibre rovings may be arranged on top and/or below such fabric.

In a preferred embodiment, the preforms used in the afore-mentioned methods are used as part of the root region of a wind turbine blade, such as the root laminate. The root region may extend up to 40 meters, such as up to 25 meters, from the root end of the blade, as seen in its longitudinal direction. In other embodiments, the root region may extend to the shoulder of the blade +/−5 meters. However, the preforms could also be used for other parts and regions of a wind turbine blade. In other embodiments, the preforms manufactured according to the afore-mentioned method are used over a length of 10-35% of the total blade length. In another embodiment, the preforms manufactured according to the afore-mentioned method are used in a region of the blade extending between its root end and a shoulder of the blade.

In another aspect, the present invention relates to a method of transferring a preform for a wind turbine blade, the method comprising
suspending a gripping device, using the lifting device according to the present invention, over the preform,
lowering the gripping device, using the lifting device according to the present invention, towards a top surface of the preform until one or more of the gripping members engage the top surface of the preform,
raising the gripping device with the engaged preform, using the lifting device according to the present invention,
arranging the engaged preform within a wind turbine blade mould, using the lifting device according to the present invention, and
disengaging the preform.

The preform will typically be transferred from a preform mould, in which the preform was formed, to the blade mould for moulding a shell part, such as an upwind or downwind shell half, of a wind turbine blade or to a mould for a full blade. The preform may thus be released in a blade mould in a substantial horizontal orientation, a substantially vertical orientation or some intermediate orientation between vertical and horizontal. The gripping device of the present invention is preferably suspended from the lifting device of the present invention.

Thus, the step of lowering and/or raising the gripping device is preferably carried out using the lifting device of the present invention for varying the suspension height of the gripping device relative to the preform. Preferably, the gripping device is lowered towards the top surface of the preform until each of the gripping members engage the top surface of the preform.

Preferably, each of the gripping arms is locked in a vertical direction when raising the gripping device with the engaged preform, such that the gripping arms are prevented from moving downwards relative to the base frame. When arranged in a wind turbine blade mould, preferably for manufacturing a blade shell half, the preform may be disengaged by retracting the needles of the respective gripping members from the preform.

In a preferred embodiment, one or more of the gripping arms of the gripping device are pushed upwards relative to the base frame by the engaged preform top surface during the step of lowering the gripping device. Thus, preferably the one or more gripping arms maintain their vertical position relative to the preform while the base frame of the gripping device is further lowered towards the preform top surface. It is thus particularly preferred that, the vertical position of one or more gripping arms of the gripping device relative to the base frame changes during the lowering step. This is because a rigid mould and a rigid gripping tool would require a very high manufacturing tolerance, or alternatively very high loads would be transferred in the first gripping arm touching the mould.

In a preferred embodiment, downward movement of one or more of the gripping arms relative to the base frame is prevented by the lock members.

In some embodiments, arranging the engaged preform within a wind turbine blade mould includes tilting or turning the preform additionally by using a pivot connector between the gripping device and the blade mould. The pivot connector may comprise a ball member for being received in a socket member, the latter being preferably attached to an edge of the wind turbine blade mould. Preferably, the socket member is affixed to a pole member at the edge of the blade mould. In some embodiments, the pole member is height-adjustable. The ball member may be received in the socket, and subsequently the gripping device may be further lowered toward the moulding cavity of the blade mould to tilt the preform and to arrange the preform in the moulding cavity.

In another aspect, the present invention relates to a method of manufacturing a wind turbine blade part, the method comprising:
manufacturing one or more preforms of a wind turbine blade part in a preform mould,
transferring each preform to a blade mould using the method of transferring a preform for a wind turbine blade according to the present invention,
infusing resin into the blade mould,
curing or hardening the resin in order to form the blade part.

When manufacturing large blade halves, the fibre layup in the blade mould at the root end may be challenging. Preforms may have to be arranged on almost vertically extending blade mould walls. Thus, in some embodiments, the methods of the present invention comprise engaging a part of a blade mould, e.g. an edge or rim thereof, comprising a socket member, with one or more pivot connectors, or parts thereof, fastened to the gripping device prior to further lowering the gripping device relative to the blade mould. The pivot connector, or part thereof, such as a ball member is adapted for being received in the socket member attached to the wind turbine blade mould.

In one embodiment, the preform mould has a length L of between 15 and 30 meters. In some embodiments, the preform mould has a length-width ratio of at least 3:1 or at least 4:1. In other embodiments, the preform mould has a length-width ratio of at least 5:1, such as at least 10:1. In a preferred embodiment, the preform mould has a length-width ratio of at least 15:1.

The present invention also relates to a blade part, such as a blade half, obtainable by the method of the present invention.

In another aspect, the present invention relates to a moulding assembly for manufacturing a shell part of a wind turbine blade, the moulding assembly comprising
a blade mould for moulding the shell part, the blade mould comprising a moulding cavity,
a gripping device for releasably engaging a preform for the shell part,
a lifting device for lifting the gripping device, and
a rigid arm with a proximal end and an opposing distal end, wherein the proximal end of the rigid arm is anchored to the blade mould, and wherein the rigid arm is releasably fastened to the gripping device at the distal end of the rigid arm or at a location in between the proximal end and the distal end of the rigid arm.

Thus, the rigid arm can be advantageously used to further guide the gripping device towards the moulding surface, or to prevent movement of the gripping device away from the moulding surface, when lowering the gripping device from the lifting device. The proximal end of the rigid arm may be fixed to an edge of the blade mould or to an outer surface of the blade mould. In some embodiments, the proximal end of the rigid arm comprises an attachment eye which can be fixed to the blade mould by using one or more screws, bolts or pins. It is particularly preferred that the rigid arm is a telescopic arm with adjustable length. In a preferred embodiment, the telescopic arm comprises a screw rod and a threaded sleeve receiving the screw rod for adjusting the length of the telescopic arm.

In another aspect, the present invention relates to a lifting assembly comprising a gripping device as described above for releasably engaging a preform for the shell part, and a lifting device comprising a first hoisting device and a second hoisting device, each of the first and second hoisting devices comprising a respective load engaging member for connecting the first and the second hoisting devices to the gripping device, wherein the gripping device is connected to the lifting device at the respective load engaging members of the first and second hoisting devices, such that the load engaging members are spaced apart from another.

It will be understood that any of the above-described features or embodiments to each of the different aspects of the present invention, such as the different moulding assemblies, the lifting assembly or the methods of the present invention. In particular, features and embodiments described with regard to the moulding assemblies or the lifting assembly may also apply to the methods of the present invention, and vice versa.

As used herein, the term “wt %” means weight percent. The term “relative to the weight of the fibre material” means a percentage that is calculated by dividing the weight of an agent, such as a binding agent, by the weight of the fibre material. As an example, a value of 1 wt % relative to the weight of the fibre material corresponds to 10 g of binding agent per kilogram of fibre material.

As used herein, the term “horizontal” means that the direction of movement is generally parallel with respect to the ground. As used herein, the terms “vertical”, “downwardly” and “upwardly” refer to directions of movement which is generally perpendicular with respect to the ground.

### DETAILED DESCRIPTION OF THE INVENTION

The invention is explained in detail below with reference to embodiments shown in the drawings, in which corresponding components are identified by the same reference numerals, wherein

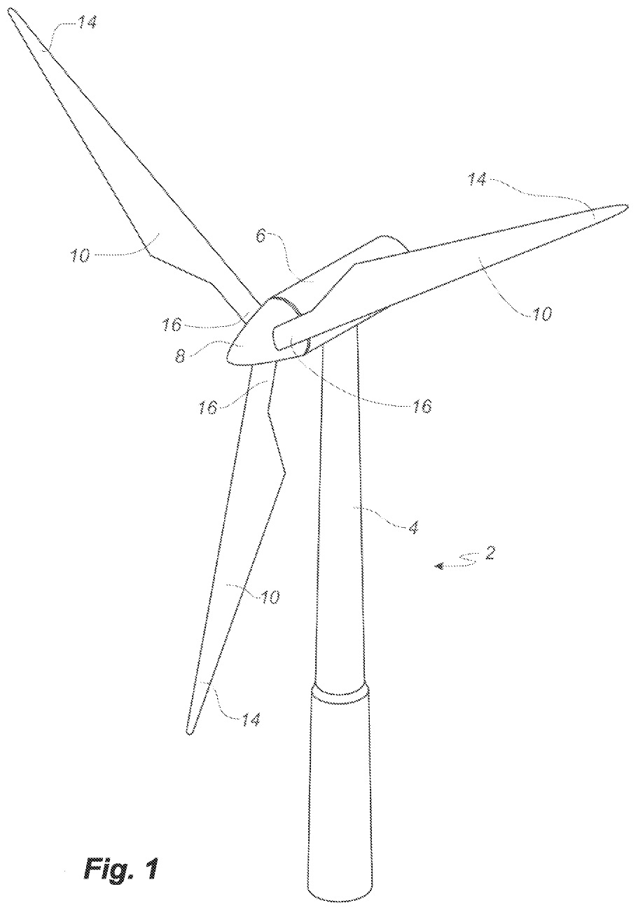

FIG. 1 shows a wind turbine,

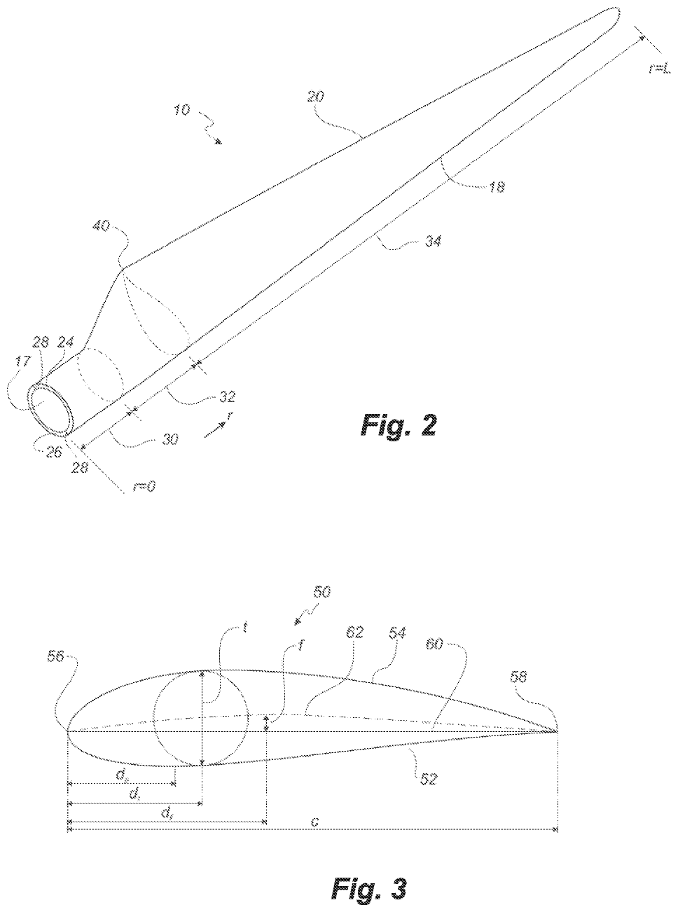

FIG. 2 shows a schematic view of a wind turbine blade,

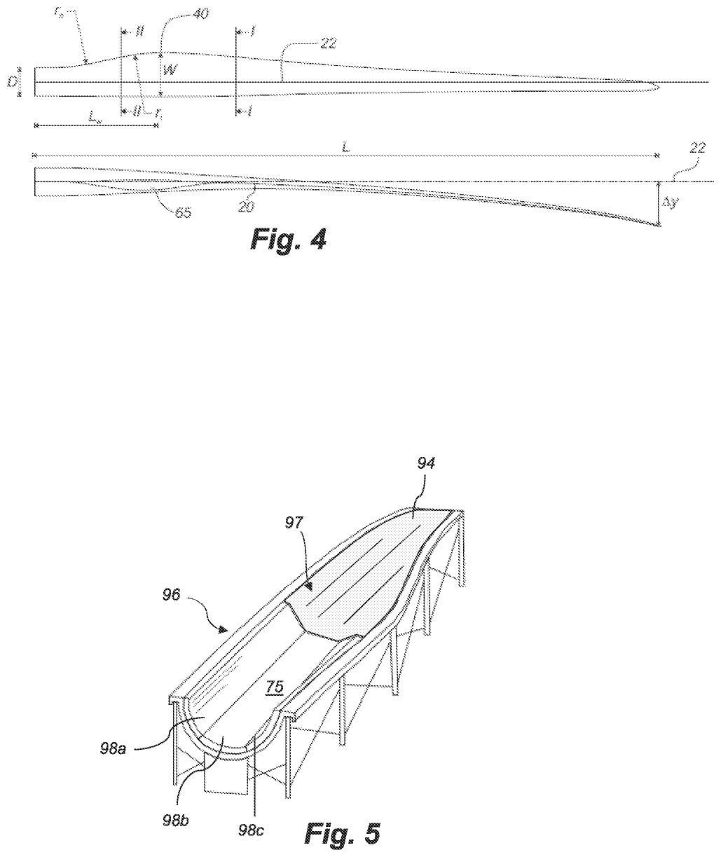

FIG. 3 shows a schematic view of an airfoil profile through section I-I of FIG. 4,

FIG. 4 shows a schematic view of the wind turbine blade, seen from above and from the side,

FIG. 5 is a perspective drawing of a blade mould for producing a wind turbine shell part according to the present invention,

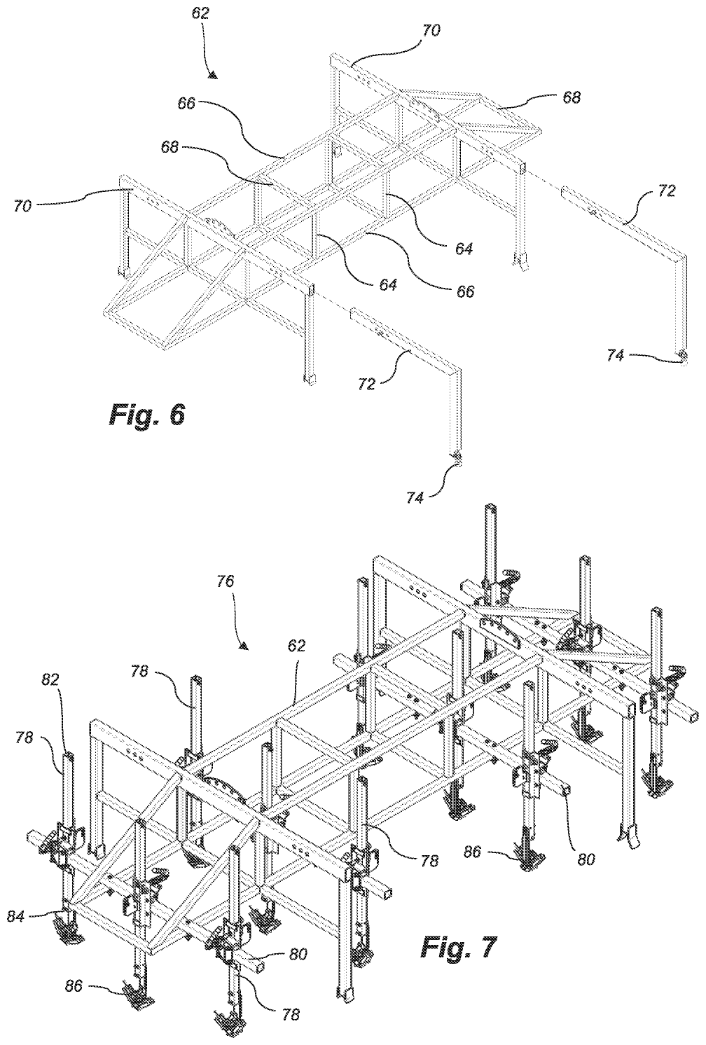

FIG. 6 is a perspective drawing of a base frame of a gripping device for use in the present invention,

FIG. 7 is a perspective drawing of a gripping device for use in the present invention,

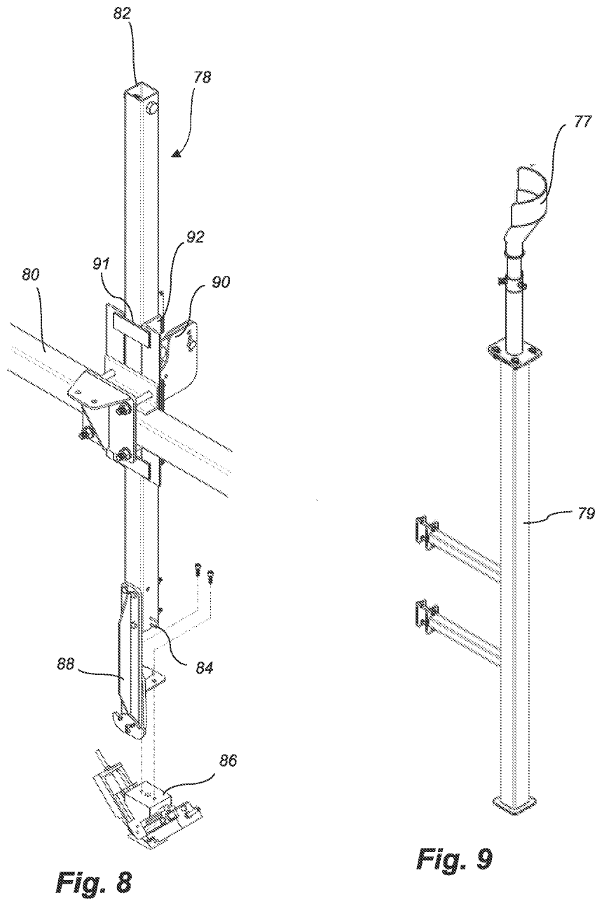

FIG. 8 is an enlarged perspective view of a gripping member and a lock member for use in the present invention,

FIG. 9 is a perspective view of a socket arrangement for mounting on a blade mould,

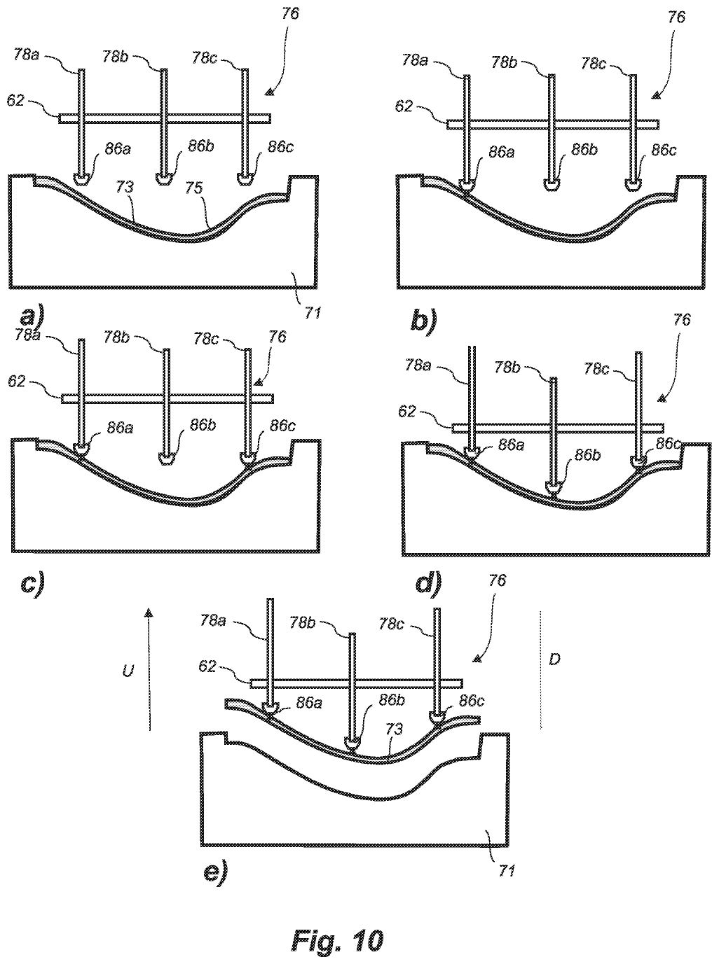

FIG. 10 is a schematic view of different steps of a method of transferring a preform for a wind turbine blade,

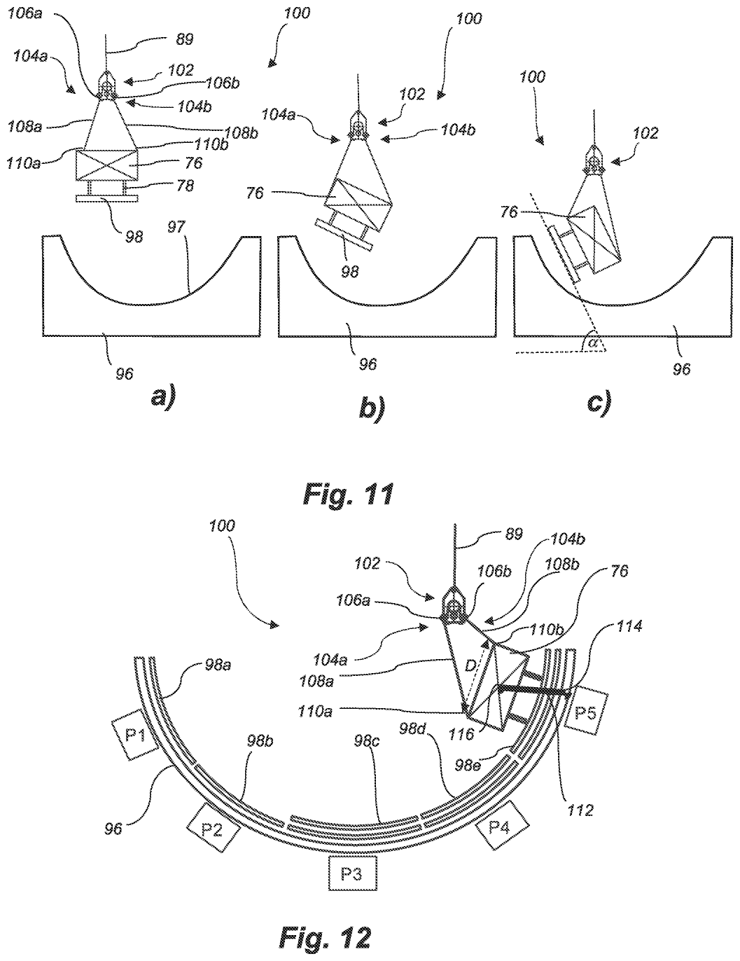

FIG. 11 is a schematic side view of a moulding assembly according to the present invention,

FIG. 12 is a schematic side view of a moulding assembly according to one embodiment of the present invention,

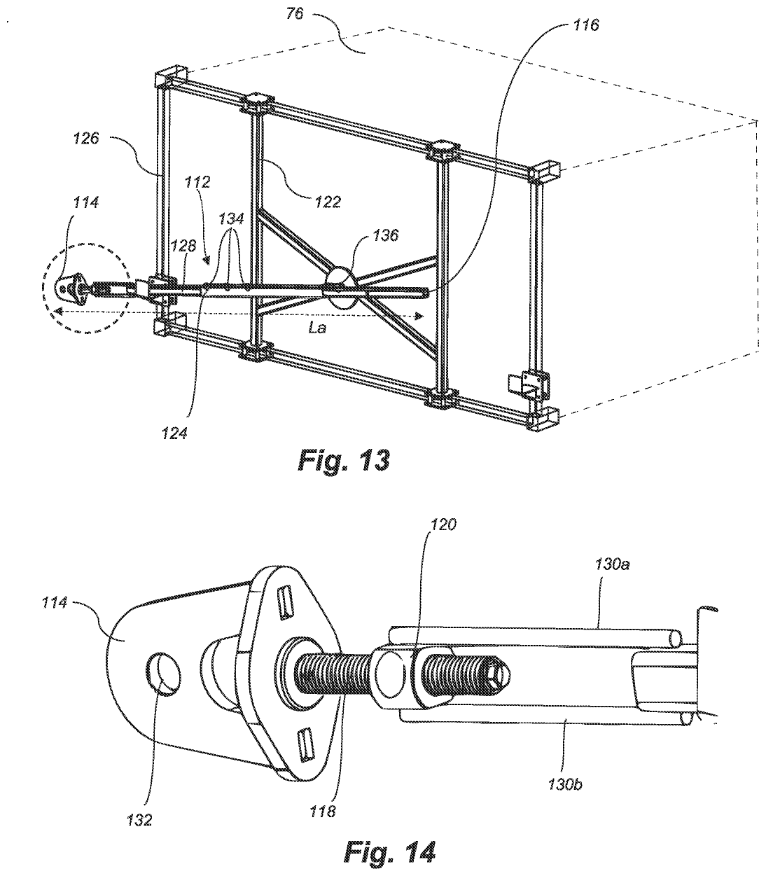

FIG. 13 is a partial perspective side view of a gripping device attached to a rigid bar for use in the present invention, and

FIG. 14 is an enlarged view of the area encircled in FIG. 13.

### DETAILED DESCRIPTION

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

FIG. 2 shows a schematic view of a first embodiment of a wind turbine blade 10. The wind turbine blade 10 has the shape of a conventional wind turbine blade and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

FIGS. 3 and 4 depict parameters which are used to explain the geometry of the wind turbine blade. FIG. 3 shows a schematic view of an airfoil profile 50 of a typical blade of a wind turbine depicted with the various parameters, which are typically used to define the geometrical shape of an airfoil. The airfoil profile 50 has a pressure side 52 and a suction side 54, which during use—i.e. during rotation of the rotor—normally face towards the windward (or upwind) side and the leeward (or downwind) side, respectively. The airfoil 50 has a chord 60 with a chord length c extending between a leading edge 56 and a trailing edge 58 of the blade. The airfoil 50 has a thickness t, which is defined as the distance between the pressure side 52 and the suction side 54. The thickness t of the airfoil varies along the chord 60. The deviation from a symmetrical profile is given by a camber line 62, which is a median line through the airfoil profile 50. The median line can be found by drawing inscribed circles from the leading edge 56 to the trailing edge 58. The median line follows the centres of these inscribed circles and the deviation or distance from the chord 60 is called the camber f The asymmetry can also be defined by use of parameters called the upper camber (or suction side camber) and lower camber (or pressure side camber), which are defined as the distances from the chord 60 and the suction side 54 and pressure side 52, respectively.

Airfoil profiles are often characterised by the following parameters: the chord length c, the maximum camber f, the position d_{f} of the maximum camber f, the maximum airfoil thickness t, which is the largest diameter of the inscribed circles along the median camber line 62, the position dₜ of the maximum thickness t, and a nose radius (not shown). These parameters are typically defined as ratios to the chord length c. Thus, a local relative blade thickness t/c is given as the ratio between the local maximum thickness t and the local chord length c. Further, the position dₚ of the maximum pressure side camber may be used as a design parameter, and of course also the position of the maximum suction side camber.

FIG. 4 shows other geometric parameters of the blade. The blade has a total blade length L. As shown in FIG. 3, the root end is located at position r=0, and the tip end located at r=L. The shoulder 40 of the blade is located at a position r=L_{w}, and has a shoulder width W, which equals the chord length at the shoulder 40. The diameter of the root is defined as D. The curvature of the trailing edge of the blade in the transition region may be defined by two parameters, viz. a minimum outer curvature radius rₒ and a minimum inner curvature radius rᵢ, which are defined as the minimum curvature radius of the trailing edge, seen from the outside (or behind the trailing edge), and the minimum curvature radius, seen from the inside (or in front of the trailing edge), respectively. Further, the blade is provided with a prebend, which is defined as □y, which corresponds to the out of plane deflection from a pitch axis 22 of the blade.

As illustrated in FIG. 5, a manufacturing process for manufacturing a blade part, such as a blade half, may involve laying a number of preforms 98a, 98b, 98c in a blade mould 96. For example, the preforms 98a, 98b, 98c are used for a blade section starting from the root end of the blade, such as the root region. The preforms 98a, 98b, 98c are arranged in the moulding cavity 97, usually together with additional fibre material 94. Then, resin is infused to the moulding cavity 97, which is subsequently cured or hardened in order to form the blade part, such as a blade half

FIG. 6 illustrates a base frame 62 for a gripping device suitable for use in the present invention. The base frame 62 may advantageously be suspended from a lifting device such as a crane or a hoist (not shown). The base frame of FIG. 6 comprises a plurality of vertically extending beams 64, a plurality of horizontally extending beams 66 in the longitudinal direction of the base frame 62, and a plurality of horizontally extending beams 68 in the transverse direction of the base frame 62.

Two horizontally extending sheath members 70 are arranged to receive respective angled support members 72, each support member 72 carrying a pivot connector 74 in the form of a ball member at its distal end. The pivot connector 74 is adapted for being received in a socket member 77 attached to a wind turbine blade mould of the type illustrated in FIG. 9. The socket member 77 may be affixed to a pole member 79 for attachment to a blade mould. Thus, when the preform held by the gripping device is suspended above a blade mould, one or more of the pivot connectors 74 may be received in one or more socket members 77 attached to the blade mould, such that the perform can be pivoted (turned) by simply lowering the same with a crane, without the need for further turning devices.

FIG. 7 illustrates an embodiment of a gripping device 76 for use in the present invention. The gripping device 76 comprises a base frame 62 of the type illustrated in FIG. 6 and a plurality of gripping arms 78 slidably mounted on the base frame 62. The gripping arms 78 may be mounted to the base frame 62 via one or more horizontally extending transverse support members 80. Alternatively, the gripping arms could be mounted directly on the frame 62, for example on the horizontally extending beams 68 in the transverse direction of the base frame 62.

Each gripping arm 78 has a proximal end 82 and a distal end 84, as also seen in the enlarged with of FIG. 8. The gripping device 76 further comprises a plurality of gripping members 86, such as needle grippers, for gripping a top surface of the preform, each gripping member being attached to the distal end 84 of at least one of the gripping arms 78, either directly or via a connection member 88. The needle gripper 86 preferably releasably attaches to the preform upon contact with the top surface of the preform.

Each gripping arm 78 also comprises a lock member 90, each lock member 90 for allowing sliding motion of the gripping arm 78 relative to the base frame 62 in an upward direction while preventing sliding motion of the gripping arm relative to the base frame in a downward direction. The lock member 90 may comprise a ratchet or a brake system. As best seen in FIG. 10, each gripping arm 78 is individually slidable relative to the base frame 62. Each gripping arm 78 may be slidably mounted within a slot 91 of a fixture 92 arranged on the base frame 62.

FIG. 10 illustrates a method of transferring a preform 73 for a wind turbine blade. The method comprises suspending a gripping device 76 over the preform 73, for example using the lifting device of the present invention. In the illustrated embodiment the preform is manufactured in a preform mould 71 and is to be transferred to a blade mould for producing a shell half of a wind turbine blade. The gripping device 76 is lowered towards a top surface 75 of the preform 73 until a first gripping member 86a engages the top surface 75 of the preform 73; see FIG. 10b. the gripping device is further lowered until a second gripping member 86c engages the preform top surface 75; FIG. 10c. Meanwhile, the gripping arm 78a carrying the first, already engaged gripping member 86a is moved upwards relative to the base frame as upward movement of the gripping arms relative to the base frame 62 is allowed. The gripping arms of the gripping device 76 are thus pushed upwards relative to the base frame 62 by the engaged preform top surface during the step of lowering the gripping device.

In FIG. 10d, also the last gripping member (needle gripper) 86 has engaged the top surface 75 of the preform 73, while the other two gripping arms 78a, 78c have moved further upwards relative to the base frame 62. Subsequently, as seen in FIG. 10e, the gripping device is raised with the engaged preform for transporting and arranging the engaged preform 73 within a wind turbine blade mould (not shown). Downward movement of the gripping arms 78a-c relative to the base frame 62 is prevented by the lock members. The upward direction U and the downward direction D are indicated in FIG. 10e. Thus, as seen in FIGS. 10a-e, the positions of the gripping arms 78a-c relative to the base frame 62 is set by the top surface geometry of the preform.

FIG. 11 is a schematic side view of a moulding assembly according to the present invention. The moulding assembly 100 comprises a blade mould 96 for moulding the shell part, usually a shell half, such as an upwind shell half or a downwind shell half of the blade. The blade mould 96 comprises a moulding cavity 97 in which preforms, fibre layers, or balsa wood can be arranged, typically followed by resin infusion in a VARTM process. The moulding assembly 100 further comprises a gripping device 76, such as a needle gripper, preferably the gripping device illustrated in the preceding figures. The gripping device 76 is operable for releasably engaging a preform 98 for the shell part. The moulding assembly 100 also comprises a lifting device 102, such as a chain hoist, preferably a dual chain hoist, the lifting device comprising a first hoisting device 104a and a second hoisting device 104b, and usually a holder, such as an upper hook which can be suspended from scaffolding, a gantry or a crane (not shown), for example by using strap 89. The lifting device may also comprise a chain hoist housing with a lifting motor that drives a chain sprocket over which the chain moves. Each of the first and second hoisting devices may take the form of a chain hoist, usually comprising a load chain and a lifting chain wheel. Each of the first and second hoisting devices comprises a respective load engaging member 110a, 110b for connecting the first and the second hoisting devices 104a, 104b to the gripping device. The load engaging members are usually arranged at the respective free ends of the load chain and can, for example, take the form of respective lower hook which can engage the gripping device.

The gripping device 76 is connected to the lifting device 102 at the respective load engaging members 110a, 110b, such as lower hooks, of the first and second hoisting devices 104a, 104b, such that the load engaging members 110a, 110b are spaced apart from another, as indicated by distance D between the two load engaging members 110a, 110b in FIG. 12. Thus, by using two hoisting devices 104a, 104b, the gripping device and the engaged preform can be tilted for accurate placement in the root region of the blade mould.

It is preferred that the first hoisting device 104a is independently operable from the second hoisting device 104b. Also, as seen in FIGS. 11 and 12, the respective load engaging members 110a, 110b of the first and second hoisting devices 104a, 104b are connected at opposing ends of the gripping device 76, for enabling a high degree of tilting.

As seen in FIG. 12, in some embodiments, the moulding assembly 100 further comprises a rigid arm 112, preferably a telescopic rigid arm 112, with a proximal end 114 and an opposing distal end 116, wherein the proximal end 114 of the rigid arm 112 is anchored to the blade mould 96 for accurate arrangement of the preform in the moulding cavity. The rigid arm 112 is releasably fastened to the gripping device 76 at the distal end 116 of the rigid arm 112 or at a location in between the proximal end 114 and the distal end 116 of the rigid arm 112. This is further illustrated in FIGS. 13 and 14.

As seen in FIGS. 13 and 14, the telescopic arm may comprise a screw rod 118 and a threaded sleeve 120 receiving the screw rod for adjusting the length of the telescopic arm. Length adjustment may be achieved by rotating the threaded sleeve 120 relative to the screw rod 118, wherein the threaded sleeve 120 is fixed to rods 130a and 130b, which are rotatably fastened to the remainder of the rigid arm 112 towards its distal end 116. As shown in FIG. 13, said remainder of the rigid arm may comprise a sliding element 128 received in a non-threaded sleeve 124 of rigid arm 112 to further adjust its length by releasing a fixture between the sliding element and the non-threaded sleeve 124, followed by re-instating the fixture, which may take the form of a pin received in regularly spaced holes 134 in the sleeve 124, as shown in FIG. 13. The overall length of the arm 112 is indicated at La in FIG. 13. Furthermore, the distal end of the rigid arm 112, or a part between the proximal and distal end of the rigid arm, may be fastened to a disc-shaped fixture 136, which is rotatably mounted on attachment frame 122, which is attached to a side structure 126 of the gripping device 76. This allows for slight changes of the angle between the rigid arm 112 and the gripping device 76, when lowering the latter into the blade mould cavity.

As illustrated in FIGS. 11 and 12, the method of the present invention comprises engaging the preform 98 for the shell part with the gripping device 76 and arranging the engaged preform within the moulding cavity 97 of the blade mould by moving the gripping device 76 and the engaged preform by means of the lifting device 102 comprising the first hoisting device and the second hoisting device, typically involving tilting the gripping device, when arranging preforms at the root region of the blade mould. This includes in particular preform locations P1 and P5 in FIG. 12, and also, to a lesser degree locations P2 and P4. FIG. 11c illustrates angle a between a plane of the engaged preform, or a tangent to the curved lower surface of the preform, and the ground surface.

As seen in FIG. 12, the step of arranging the engaged preform within the moulding cavity may comprise engaging the gripping device with the rigid arm 112 while lowering the gripping device 76 and the engaged preform towards the moulding cavity 9) by means of the lifting device 102. Thus, the angle of the gripping device carrying the preform can further be modified to achieve the accurate angle for preform placement, e.g. by preventing movement of the tilted gripping device away from the mould cavity, or by slightly pulling the gripping device towards the blade mould cavity when employing a telescopic rigid bar. This can be achieved, for example, by using the screw rod 118 and a threaded sleeve 120 as explained above.

The invention is not limited to the embodiments described herein and may be modified or adapted without departing from the scope of the present invention.

### LIST OF REFERENCE NUMERALS

2 wind turbine

4 tower

6 nacelle

8 hub

10 blade

14 blade tip

16 blade root

18 leading edge

20 trailing edge

22 pitch axis

30 root region

32 transition region

34 airfoil region

40 shoulder/position of maximum chord

50 airfoil profile

52 pressure side

54 suction side

56 leading edge

58 trailing edge

60 chord

62 base frame

64 vertical beams

66 horizontal beams, longitudinal direction

68 horizontal beams, transverse direction

70 sheath member

71 preform mould

72 angled support member

73 preform

74 pivot connector

75 top surface of preform

76 gripping device

77 socket member

78 gripping arm

79 pole member

80 transverse support members

82 proximal end of gripping arm

84 distal end of gripping arm

86 gripping member

88 connection member

89 strap

90 lock member

91 slot

92 fixture

94 fibre material

96 blade mould

97 moulding cavity

98 preform

100 moulding assembly

102 lifting device

104 hoisting device

106 wheel

108 load chain

110 load engaging member

112 rigid arm

114 proximal end of rigid arm

116 distal end of rigid arm

118 screw rod

120 threaded sleeve

122 attachment frame

124 non-threaded sleeve of rigid arm

126 side structure of gripping device

128 sliding element

130 bar

132 attachment eye

134 hole in non-threaded sleeve

136 disc-shaped fixture

c chord length

dₜ position of maximum thickness

d_{f} position of maximum camber

dₚ position of maximum pressure side camber

f camber

L blade length

La length of rigid arm

r local radius, radial distance from blade root

t thickness

□y prebend

1-15. (canceled)

16. A moulding assembly for manufacturing a shell part of a wind turbine blade, comprising
a blade mould, the blade mould comprising a moulding cavity;
a gripping device configured to releasably engage a preform for the shell part;
a lifting device comprising a first hoisting device and a second hoisting device, each of the first and second hoisting devices comprising a respective load engaging member for connecting the first and the second hoisting devices to the gripping device; and
wherein the gripping device is connected to the lifting device at the respective load engaging members of the first and second hoisting devices, such that the load engaging members are spaced apart from another.

17. The moulding assembly according to claim 16, further comprising a rigid arm with a proximal end and an opposing distal end, the proximal end of the rigid arm anchored to the blade mould, and wherein the rigid arm is releasably fastened to the gripping device at the distal end or at a location in between the proximal end and the distal end of the rigid arm.

18. The moulding assembly according to claim 17, wherein the rigid arm is a telescopic arm with an adjustable length.

19. The moulding assembly according to claim 18, wherein the telescopic arm comprises a screw rod and a threaded sleeve receiving the screw rod for adjusting the length of the telescopic arm.

20. The moulding assembly according to claim 16, wherein the first hoisting device is independently operable from the second hoisting device.

21. The moulding assembly according to claim 16, wherein the respective load engaging members of the first and second hoisting devices are connected at opposing ends of the gripping device.

22. The moulding assembly according to claim 21, wherein one or both the first hoisting device and the second hoisting device comprise a chain hoist with a load chain, the respective load engaging member located at a free end of the load chain.

23. The moulding assembly according to claim 22, wherein the lifting device comprises a dual chain hoist arrangement comprising a first chain wheel which is part of the first hoisting device, and a second chain wheel which is part of the second hoisting device.

24. The moulding assembly according to claim 16, wherein the blade mould comprises a first mould edge and an opposing second mould edge, wherein the moulding assembly further comprises a socket member attached to the first or to the second mould edge, the gripping device comprising one or more pivot connectors received in the socket members.

25. The moulding assembly according to claim 16, wherein the gripping device comprises:
a base frame;
a plurality of gripping arms slidably mounted on the base frame, each gripping arm having a proximal end and a distal end;
a plurality of gripping members configured to grip a top surface of the preform, each gripping member being attached to the distal end of one of the gripping arms; and
a plurality of lock members, each lock member engaged with one of the gripping arms to enable sliding motion of the gripping arm relative to the base frame in a first direction while preventing sliding motion of the gripping arm relative to the base frame in a second direction.

26. A method of manufacturing a shell part of a wind turbine blade using the moulding assembly according to claim 16, the method comprising
engaging a preform for the shell part with the gripping device;
arranging the engaged preform within the moulding cavity of the blade mould by moving the gripping device and the engaged preform with the lifting device; and
disengaging the preform from the gripping device.

27. The method according to claim 26, wherein the step of arranging the engaged preform within the moulding cavity of the blade mould includes tilting the gripping device with the lifting device.

28. The method according to claim 26, wherein the step of arranging the engaged preform within the moulding cavity comprises engaging the gripping device with a rigid arm while lowering the gripping device and the engaged preform towards the moulding cavity with the lifting device.

29. The method according to claim 26, wherein the preform is manufactured in a preform mould prior to engaging the preform with the gripping device, the further comprising transferring the engaged preform to the blade mould using the lifting device and the connected gripping device prior to arranging the engaged preform within the moulding cavity of the blade mould.

30. The method according to claim 26, further comprising infusing resin into the blade mould after disengaging the preform from the gripping device, and curing or hardening the resin in order to form the shell part.
